(19) United States
(12) Patent Application Publication
(10) Pub. No.: US 2018/0250197 A1
(43) Pub. Date: Sep. 6, 2018

(54) TETHERING DEVICE FOR A CUP

(71) Applicant: YOUR SOLUTIONS, LLC, St. Peters, MO (US)

(72) Inventor: JoyLynn Waganer, St. Peters, MO (US)

(21) Appl. No.: 15/895,544

(22) Filed: Feb. 13, 2018

Related U.S. Application Data
(60) Provisional application No. 62/467,246, filed on Mar. 6, 2017.

(51) Int. Cl. A61J 9/06; F16B 47/00

(52) U.S. Cl. CPC A61J 9/0661; A61J 17/02; F16B 47/00

(57) ABSTRACT

A tethering device for a cup is disclosed having a suction cup device having a first handle and a movable second handle, a first link connected to the first handle, and a lockable link connected to the first link. Another tethering device for a cup is disclosed having a suction cup device having a first handle and a movable second handle, a first link connected to the first handle, a series of links having one of the links of the series of links connected to the first link, and a lockable link connected to another one of the links in the series of links.

### RELATED APPLICATION

This application claims priority to U.S. Provisional Patent Application No. 62/467,246, which was filed on Mar. 1, 2017, the disclosure of which is incorporated herein by reference.

### BACKGROUND

This disclosure relates to a tethering device for a cup and more particularly to a tethering device for a drinking cup for an infant or child that allows the cup to be retrieved for continued use.

When an infant or child is holding a bottle, a cup, or a sippy cup, the infant or child may have a tendency to throw the bottle or cup. At first this may be an accident but eventually the infant or child may learn that it garners attention from a parent in that the parent must retrieve the bottle or cup. It is also possible that the bottle or cup may be thrown at an inappropriate time. For example, if the child is in a car seat in a back seat of a car and throws the cup then the person driving the car may become distracted which could lead to an accident.

Therefore, it would be desirable to have a tethering device for a cup that allows for the cup to be easily retrieved for continued use by an infant or child. It would also be desirable to have a tethering device for a cup that is universal and may be used to connect any sized cup to the tethering device. It would also be advantageous to have a tethering device for a cup that is fanciful to capture an infant's or a child's attention during use of the tethering device for a cup.

### BRIEF SUMMARY

In one form of the present disclosure, a tethering device for a cup comprises a suction cup device having a first handle and a movable second handle, a first link connected to the first handle, and a lockable link connected to the first link.

In another form of the present disclosure, a tethering device for a cup comprises a suction cup device having a first handle and a movable second handle, a first link connected to the first handle, a lockable link connected to the first link, and a band connected to the lockable link with the band for securing a cup therein.

In yet another form of the present disclosure, a tethering device for a cup comprises a suction cup device having a first handle and a movable second handle, a first link connected to the first handle, a series of links having one of the links of the series of links connected to the first link, and a lockable link connected to another one of the links of the series of links.

The present disclosure provides a tethering device for a cup that allows the cup to be easily retrieved if the cup is thrown or knocked over.

The present disclosure provides a tethering device for a cup that is capable of being secured to a cup so that the cup is not lost.

The present disclosure provides a tethering device for a cup that is lightweight, easy to handle, easy to install, and easy to use.

The present disclosure also provides a tethering device for a cup which is of simple construction and design and which can be easily employed with highly reliable results.

The present disclosure is also directed to a tethering device for a cup that does not require any special tools to attach the cup to the tethering device.

The present disclosure is also directed to a tethering device for a cup that is made of a lightweight material such as plastic, polyethylene, and high density polyethylene or any other similar material so that the device can be cleaned.

The present disclosure is further related to a tethering device for a cup that can be customized and may be expandable to hold or tether various other items such as toys or bottles.

The present disclosure is directed to a tethering device for a cup that may comprise many different colors to provide an attractive device.

The present disclosure is related to a tethering device for a cup that may be connected to any sized cup that has a handle or to other items that have a handle.

The present disclosure is directed to a tethering device for a cup that does not interfere with the use of the cup and allows an infant or a child to grip the cup during use.

These and other advantages of the present disclosure will become apparent after considering the following detailed specification in conjunction with the accompanying drawings, wherein:

### BRIEF DESCRIPTION OF THE DRAWINGS

FIG. 1 is a perspective view of a tethering device for a cup constructed according to the present disclosure;

FIG. 2 is a perspective view of a suction cup device constructed according to the present disclosure;

FIG. 3 is a side view of a lockable link constructed according to the present disclosure;

FIG. 4 is a perspective view of another preferred embodiment of a tethering device for a cup constructed according to the present disclosure;

FIG. 5 is a perspective view of another preferred embodiment of a tethering device for a cup constructed according to the present disclosure;

FIG. 6 is a perspective view of still another preferred embodiment of a tethering device for a cup constructed according to the present disclosure; and

FIG. 7 is a perspective view of yet another preferred embodiment of a tethering device for a cup constructed according to the present disclosure.

### DETAILED DESCRIPTION OF PREFERRED EMBODIMENTS

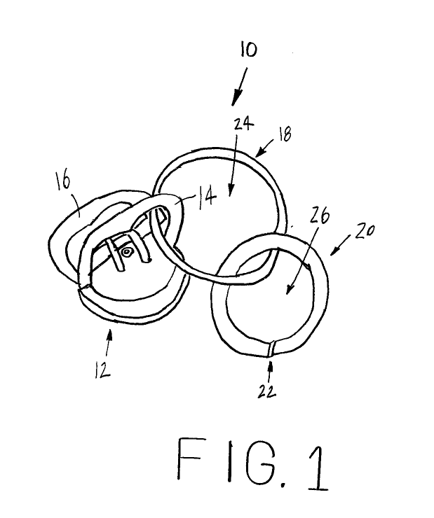

Referring now to the drawings, wherein like numbers refer to like items, number 10 identifies a tethering device for a cup constructed according to the present disclosure. With reference now to FIG. 1, the device 10 comprises a vacuum suction cup device 12 having a first handle 14 and a second movable handle 16, a first link 18 connected to the first handle 14, and a lockable link 20 connected to the first link 18. The lockable link 20 has a locking mechanism 22 that allows the link 20 to be opened or closed. Although not shown, the lockable link 20 may be opened to allow a handle of a cup, such as a sippy cup, to be inserted therein and then close or lock the lockable link 20 to secure the cup therein. Although the lockable link 20 has been described as securing a cup therein, it is also possible that any other item is capable of being secured within the link 20. By way of example only, a bottle having a securing device that may be captured by the link 20, a blanket, a blanket having a grommet or other opening, or a toy are other possible items that may be secured by the device 10. Further, the word cup is herein defined to be or include any other item. The first link 18 is generally circular and has a first diameter 24. The lockable link 20 is also generally circular and has a second diameter 26. The first diameter 24 is greater than the second diameter 26. Although the links 18 and 20 are shown as being circular in construction, it is possible that other configurations such as oval, square, rectangular, triangular, or a combination thereof may be used. The links 18 and 20 may be constructed of any suitable material such as plastic, polyethylene, high density polyethylene, metal, wood, glass, or any other suitable material. However, plastic is the preferred material. Further, the links 18 and 20 may have colors such as primary colors or the links 18 and 20 may be clear. By way of example only, the link 18 may be clear and the lockable link 20 may be purple. It is also contemplated that the links 18 and 20 may incorporate designs, logos, or lettering. The link 18 may also consists of a stretchy food grade material that is safe for an infant or a child to chew or teethe.

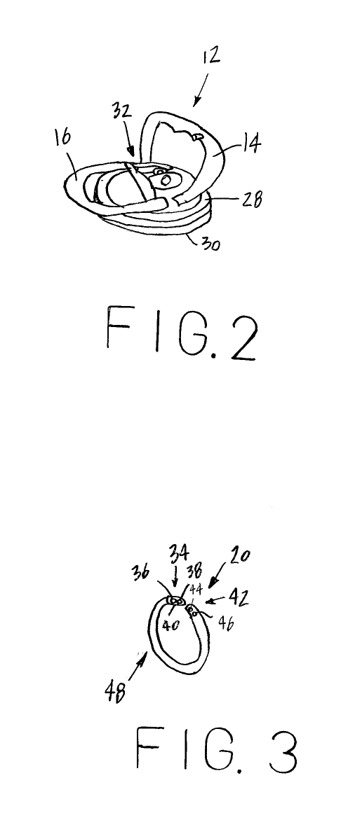

FIG. 2 shows a perspective view of the vacuum suction cup device 12. The vacuum suction cup device 12 has a base 28 having a suction surface 30. The second handle 16 is used to create a vacuum for the suction surface 30 to attach to a surface (not shown), such as a high chair, a car seat, a table, or a stroller. The second handle 16 is shown in an opened position meaning that no vacuum has been created and the suction surface 30 is free to be moved. The second handle 16 may be connected to a spring loaded mechanism 32 to aid in creating a vacuum. The first handle 14 is in a stationary position and does not move. In order to operate the vacuum suction cup device 12 the second handle 16 is moved upwardly toward the first handle 14. This creates a vacuum and attaches the suction surface 30 to another surface (not shown). The vacuum suction cup device 12 is adhered in place.

With reference now to FIG. 3, a perspective view of the lockable link 20 is shown being in an unlocked position. The lockable link 20 has a first end 34 having a pair of tab members 36 and 38 which extend out from a base surface 40. The lockable link 20 also has a second end 42 having a pair of openings 44 and 46 which receive the tab members 36 and 38 to lock the second end 42 to the first end 34. The lockable line 20 is locked by placing the tab members 36 and 38 into the openings 44 and 46. In this manner the lockable line 20 is difficult for an infant or a child to unlock the link 20. The lockable link 20 also comprises a circular body 48 with the tab members 36 and 38 of the first end 34 for extending through the openings 44 and 46 of the second end 42 for locking the lockable link 20.

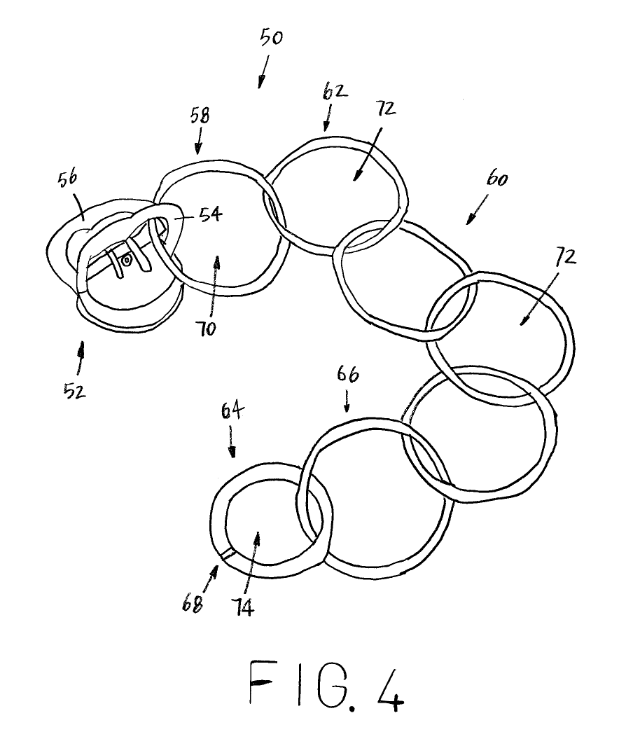

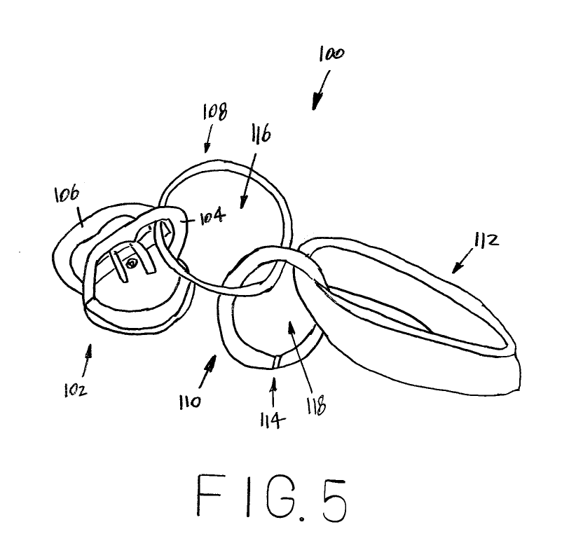

FIG. 4 illustrates another embodiment of a tethering device for a cup 50 constructed according to the present disclosure. The device 50 comprises a vacuum suction cup device 52 having a first handle 54 and a second movable handle 56, a first handle link 58 connected to the first handle 54, a series of links 60 having a first link 62 in the series of links 60 connected to the first handle 54, and a lockable link 64 connected to a second link 66 in the series of links 60. The lockable link 64 has a locking mechanism 68 that allows the lockable link 64 to be opened or closed. Although not shown, the lockable link 64 may be opened to allow a handle of a cup, such as a sippy cup, to be inserted therein and then close or lock the lockable link 64 to secure the cup therein. The first handle link 58 is generally circular and has a first diameter 70. The series of links 60 each have a link diameter 72. The lockable link 64 is also generally circular and has a second diameter 74. The first diameter 70 is greater than the second diameter 74. Although the links 58, 60, and 64 are shown as being circular in construction, it is possible that other configurations such as oval, square, rectangular, triangular, or a combination thereof may be used. The links 58, 60, and 64 may be constructed of any suitable material such as plastic, polyethylene, high density polyethylene, metal, wood, glass, or any other suitable material. The links 58 and 60 may also consist of a stretchy food grade material that is safe for an infant or a child to chew or teethe.

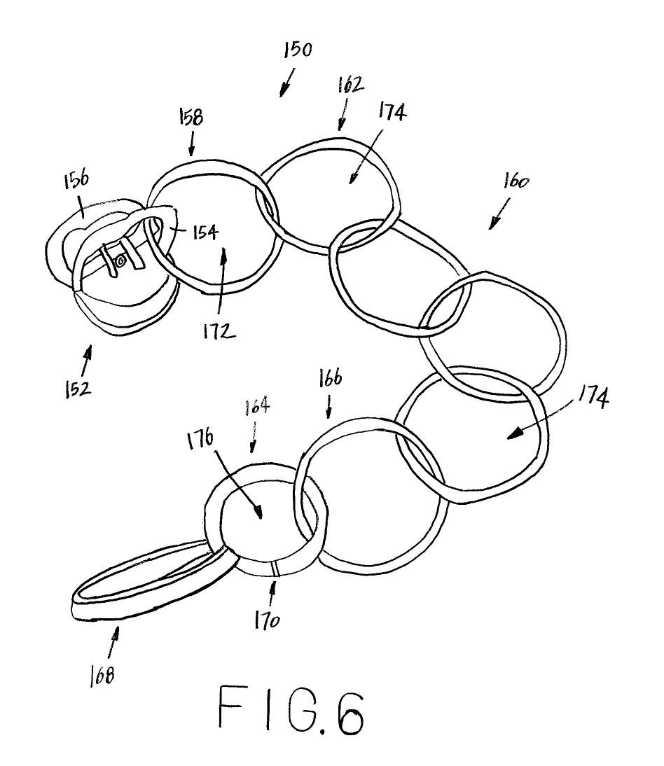

Referring now in particular to FIG. 5, another embodiment of a tethering device for a cup 100 is depicted. The device 100 is shown comprising a vacuum suction cup device 102 having a first handle 104 and a second movable handle 106, a first link 108 connected to the first handle 104, a lockable link 110 connected to the first link 108, and a band 112 connected to the lockable link 110. The lockable link 110 has a locking mechanism 114 that allows the link 110 to be opened or closed to receive the first link 108 and the band 112. The band 112 is used to secure a cup or bottle therein. The first link 108 is generally circular and has a first diameter 116. The lockable link 110 is also generally circular and has a second diameter 118. The first diameter 116 is greater than the second diameter 118. Although the links 108 and 110 are shown as being circular in construction, it is possible that other configurations such as oval, square, rectangular, triangular, or a combination thereof may be used. The links 108 and 110 may be constructed of any suitable material such as plastic, polyethylene, high density polyethylene, metal, wood, glass, or any other suitable material. The link 108 may also consists of a stretchy food grade material that is safe for an infant or a child to chew or teethe. The band 112 may constructed of a rubber material which allows the band 112 to expand to receive a cup or a bottle. Although not shown, it is possible that the band 112 may have a slogan imprinted thereon.

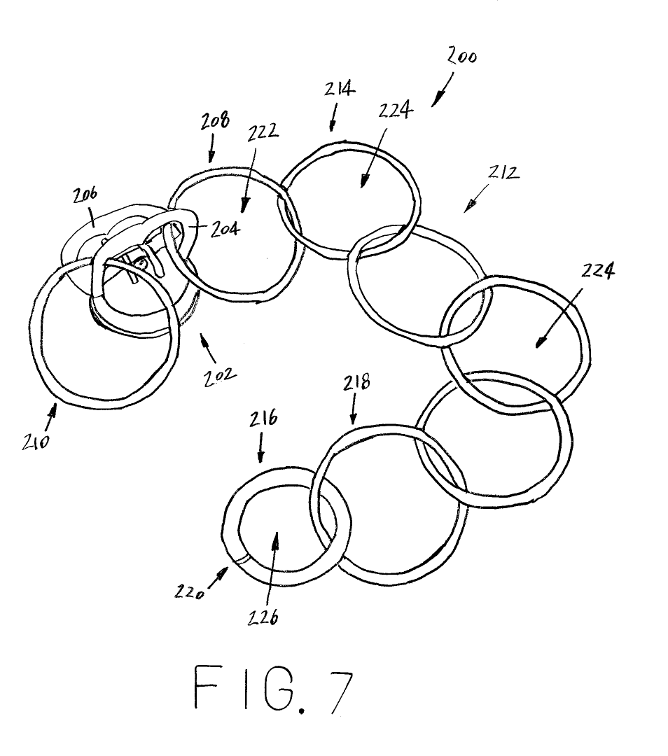

FIG. 6 shows another embodiment of a tethering device for a cup 150. The tethering device for a cup 150 comprises a vacuum suction cup device 152 having a first handle 154 and a second movable handle 156, a first handle link 158 connected to the first handle 154, a series of links 160 having a first link 162 in the series of links 160 connected to the first handle 154, a lockable link 164 connected to a second link 166 in the series of links 160, and a band 168 connected to the lockable link 164. The lockable link 164 has a locking mechanism 170 that allows the link 164 to be opened or closed to receive the band 168. The band 168 is used to secure a cup or bottle therein. The first handle link 158 is generally circular and has a first diameter 172. The series of links 160 each have a link diameter 174. The lockable link 164 is also generally circular and has a second diameter 176. The first diameter 172 is greater than the second diameter 176. Although the links 158, 160, and 164 are shown as being circular in construction, it is possible that other configurations such as oval, square, rectangular, triangular, or a combination thereof may be used. The links 158, 160, and 164 may be constructed of any suitable material such as plastic, polyethylene, high density polyethylene, metal, wood, glass, or any other suitable material. The links 158 and 160 may also consist of a stretchy food grade material that is safe for an infant or a child to chew or teethe. The band 168 may constructed of a rubber material which allows the band 168 to expand to receive or capture a cup or a bottle therein.

With reference now to FIG. 7, another embodiment of a tethering device for a cup 200 is illustrated. The device 200 comprises The device 200 comprises a vacuum suction cup device 202 having a first handle 204 and a second movable handle 206, a first handle link 208 connected to the first handle 204, a second handle link 210 connected to the first handle 204, a series of links 212 having a first link 214 in the series of links 212 connected to the first handle link 208, and a lockable link 216 connected to a second link 218 in the series of links 212. The lockable link 216 has a locking mechanism 220 that allows the lockable link 216 to be opened or closed. Although not shown, the lockable link 216 may be opened to allow a handle of a cup, such as a sippy cup, to be inserted therein and then close or lock the lockable link 216 to secure the cup therein. The first handle link 208 is generally circular and has a first diameter 222. The series of links 60 each have a link diameter 224. The lockable link 216 is also generally circular and has a second diameter 226. The first diameter 222 is greater than the second diameter 226. Although the links 208, 212, and 216 are shown as being circular in construction, it is possible that other configurations such as oval, square, rectangular, triangular, or a combination thereof may be used. The links 208, 212, and 216 may be constructed of any suitable material such as plastic, polyethylene, high density polyethylene, metal, wood, glass, or any other suitable material. As indicated above, the links 208, 212, and 216 may incorporate different colors or be clear. The links 208, 210, and 212 may also consist of a stretchy food grade material that is safe for an infant or a child to chew or teethe. The second handle link 210 may be used to attach another series of links 212 thereto to expand or customize the device 200.

In operation, the various devices 10, 50, and 200 may operate in the following manner. The suction cup devices 12, 52, and 202 are placed on a surface (not shown) and the devices 12, 52, and 202 are operated to suction the devices 12, 52, and 202 to the surface. A cup (not shown) is secured to the lockable links 20, 64, and 216. If an infant or child using the devices 10, 50, and 200 throws a cup attached thereto, the cup will be easily retrieved due to the lockable links 20, 64, and 216 being connected to the suction cup devices 12, 52, and 202. The devices 100 and 150 may operate as follows. The suction cup devices 102 and 152 are placed on a surface and suctioned into place by operating the suction cup devices 102 and 152. As has been previously indicated, the suction cup devices 102 and 152 are actuated by moving the second handles 106 and 156 upwardly next to the first handles 104 and 154. A cup may be inserted into the bands 112 and 168 to secure the cup therein. When an infant or a child throws the cup attached to the devices 100 and 150 the cup may be retrieved due to the links 108 and 110 associated with the device 100 and the links 158, 160, and 164 associated with the device 150.

From all that has been said, it will be clear that there has thus been shown and described herein a tethering device for a cup which fulfills the various advantages sought therefore. It will become apparent to those skilled in the art, however, that many changes, modifications, variations, and other uses and applications of the subject tethering device for a cup are possible and contemplated. All changes, modifications, variations, and other uses and applications which do not depart from the spirit and scope of the disclosure are deemed to be covered by the disclosure, which is limited only by the claims which follow.

What is claimed is:

1. A tethering device for a cup comprising:
a suction cup device having a first handle and a movable second handle;
a first link connected to the first handle; and
a lockable link connected to the first link.

2. The tethering device for a cup of claim 1 further comprising a second link connected to the first handle.

3. The tethering device for a cup of claim 1 wherein the first link is circular and has a first diameter, the lockable link is circular and has a second diameter, and the first diameter is greater than the second diameter.

4. The tethering device for a cup of claim 1 wherein the first link and the lockable link are constructed of plastic.

5. The tethering device for a cup of claim 1 wherein the first link has a first color and the lockable link has a second color.

6. The tethering device for a cup of claim 1 wherein the lockable link comprises a circular body having a first end having a pair of tab members and a second end having a pair of openings with the tab members of the first end for extending through the openings of the second end for locking the lockable link.

7. The tethering device for a cup of claim 1 further comprising a second link connected to the first handle, the second link is circular and has a first diameter, the lockable link is circular and has a second diameter, and the first diameter is greater than the second diameter.

8. A tethering device for a cup comprising:
a suction cup device having a first handle and a movable second handle;
a first link connected to the first handle;
a lockable link connected to the first link; and
a band connected to the lockable link with the band for securing a cup therein.

9. The tethering device for a cup of claim 8 wherein the first link is circular and has a first diameter, the lockable link is circular and has a second diameter, and the first diameter is greater than the second diameter.

10. The tethering device for a cup of claim 8 wherein the first link and the lockable link are constructed of plastic.

11. The tethering device for a cup of claim 8 wherein the first link has a first color and the lockable link has a second color.

12. The tethering device for a cup of claim 8 further comprising a second link connected to the first handle.

13. The tethering device for a cup of claim 8 wherein the lockable link comprises a circular body having a first end having a pair of tab members and a second end having a pair of openings with the tab members of the first end for extending through the openings of the second end for locking the lockable link.

14. The tethering device for a cup of claim 8 further comprising a second link connected to the first handle, the second link is circular and has a first diameter, the lockable link is circular and has a second diameter, and the first diameter is greater than the second diameter.

15. A tethering device for a cup comprising:
a suction cup device having a first handle and a movable second handle;
a first link connected to the first handle;
a series of links having one of the links of the series of links connected to the first link; and
a lockable link connected to another one of the links of the series of links.

16. The tethering device for a cup of claim 15 wherein the first link is circular and has a first diameter, the lockable link is circular and has a second diameter, and the first diameter is greater than the second diameter.

17. The tethering device for a cup of claim 15 wherein the first link is circular and has a first diameter, each of the links in the series of links are circular and have a second diameter, the lockable link is circular and has a third diameter, and the first diameter is greater than the third diameter.

18. The tethering device for a cup of claim 17 wherein the second diameter is greater than the third diameter.

19. The tethering device for a cup of claim 15 wherein the lockable link comprises a circular body having a first end having a pair of tab members and a second end having a pair of openings with the tab members of the first end for extending through the openings of the second end for locking the lockable link.

20. The tethering device for a cup of claim 15 further comprising a second link connected to the first handle.
